(19) United States
(12) Patent Application Publication
(10) Pub. No.: US 2013/0262090 A1
(43) Pub. Date: Oct. 3, 2013

(54) SYSTEM AND METHOD FOR REDUCING SEMANTIC AMBIGUITY

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: YU-KAI XIONG, Shenzhen (CN); XIN LU, Shenzhen (CN); SHIH-FANG WONG, New Taipei (TW); HUI-FENG LIU, Shenzhen (CN); DONG-SHENG LV, Shenzhen (CN); YU-YONG ZHANG, Shenzhen (CN); JIAN-JIAN ZHU, Shenzhen (CN); XIANG-LIN CHENG, Shenzhen (CN); JIAN-LIN XIONG, Shenzhen (CN); XIAO-SHAN ZHOU, Shenzhen (CN); XUAN-FEN HUANG, Shenzhen (CN); AN-LIN JIANG, Shenzhen (CN); XIN-HUA LI, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/853,076

(22) Filed: Mar. 29, 2013

(30) Foreign Application Priority Data
Mar. 29, 2012 (CN) 201210087542.8

(51) Int. Cl. G06F 17/28

(52) U.S. Cl. CPC G06F 17/28
USPC 704/9

(57) ABSTRACT

A semantic ambiguity reduction system deconstructs the sentence into a number of basic word units according to predetermined word definitions and semantic logic rules. The semantic ambiguity reduction system acquires the semantic judgments based on the basic word units and the semantic logic rules, stores the semantic judgment if only one semantic judgment of the sentence is acquired, and determines a number of keywords of a semantic ambiguity if more than one semantic judgment is acquired. The semantic ambiguity determines critical information by searching the keywords in the word definitions and the semantic judgments being stored, and selects one semantic judgment from the more than one semantic judgment about the sentence according to the critical information.

### TECHNICAL FIELD

The disclosure generally relates to semantic recognition technologies, and particularly, to a system and method for reducing semantic ambiguity in sentences.

### DESCRIPTION OF RELATED ART

A typical semantic recognition system usually analyzes a sentence according to some preset semantic logical relation. However, because of flexibility of language description, semantic analysis of the sentence often results in more than one semantic interpretation, which leads to a break of the semantic analysis.

Therefore, it is desirable to provide a means, which can overcome the above-mentioned problems.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic apparatus.

FIG. 2 is a flowchart of an exemplary embodiment of a semantic ambiguity eliminating method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable median include CDs, DVDs, BLU-RAY, flash memory, and hard disk drives.

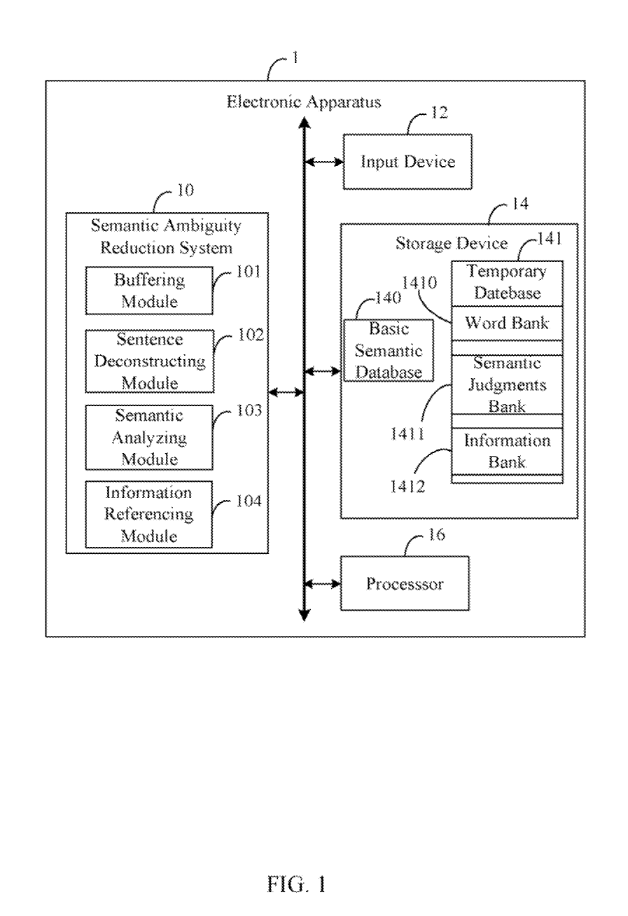

FIG. 1 is a block diagram of one embodiment of an electronic apparatus 1. The electronic apparatus 1 includes a semantic ambiguity reduction system 10. In one embodiment, the electronic apparatus 1 further includes an input device 12, a storage device 14, and at least one processor 16. The input device 12, the storage device 14, and the at least one processor 16 are directly or indirectly electronically connected, for data exchange. In this embodiment, the electronic apparatus 1 may be, but is not limited to, a computer or an intelligent mobile terminal, such as a tablet computer or a cellular phone.

The input device 12 is configured to input the sentences into the electronic apparatus 1. The sentences can be input by manual operation or an audio collection. Correspondingly, the input device 12 may be, but is not limited to, a mouse, a microphone, a keyboard, or a touch panel.

The storage device 14 may be, but is not limited to, a hard disk, or a dedicated memory, such as an EPROM, HDD, or flash memory. The storage device 14 stores the sentences input by the input device 12, a predetermined basic semantic database 140, and temporary information generated during the semantic analysis process. The basic semantic database 140 includes word definitions and semantic logic rules.

The semantic ambiguity reduction system 10 includes a buffering module 101, a sentence deconstructing module 102, a semantic analyzing module 103, and an information referencing module 104. Computerized codes of the semantic ambiguity reduction system 10 can be embedded in an operating system of the electronic apparatus 1, or stored in the storage device 14 and executed by the processor 16.

The buffering module 101 establishes a temporary database 141 in the storage device 14 when a newly input sentence is analyzed. The temporary database 141 is configured to store the temporary information generated during the semantic analysis process. The temporary information may include, but is not limited to, a number of basic word units deconstructed from the sentence, a number of keywords, and a number of definite semantic judgments based on exited semantic logic rules. The basic word units are a number of basic elements constituting the sentence. The basic word units are defined by the word definitions and the semantic logic rules. For example, a sentence of “I love Flora as well as Felicia” can be deconstructed into the basic word units of “I”, “love” “Flora”, “as well as”, and “Felicia”. The keyword are the basic word units related to semantic ambiguity of the sentence. For example, in this embodiment, the keywords may be “I”, “Flora”, and “Felicia”. The semantic judgment is a logic judgment about a meaning of the sentence. The semantic judgment can be acquired by analyzing the basic word units and the predetermined semantic logic rules. For example, in this embodiment, “I” is a subject of the sentence. “Love” is a predicate verb of simple present time. “Flora” is an object of the sentence. According to a predetermined semantic logic rule of “the action of simple present time made by the subject of the sentence is accepted by the object of the sentence”, a semantic judgment of “I give an action of love to Flora” about the sentence is acquired. The buffering module 101 clears the temporary database 141 when the entire semantic analysis process is finished.

The sentence deconstructing module 102 deconstructs the input sentence into the basic word units according to the word definitions and the semantic logic rules stored in the basic semantic database 140. The sentence deconstructing module 102 establishes a word bank 1410 in the temporary database 141. The basic word units are stored in the word bank 1410.

The semantic analyzing module 103 analyzes the basic word units to acquire the semantic judgments based on the predetermined semantic logic rules stored in the basic semantic database 140. The semantic analyzing module 103 establishes a semantic judgments bank 1411 in the temporary database 141. If there is only one semantic judgment about the input sentence acquired according to the predetermined semantic logic rules, the semantic analyzing module 103 stores the semantic judgments in the semantic judgment bank orderly. The definite semantic judgments can be referenced by the coming semantic analysis.

During the semantic analysis process, the semantic analyzing module 103 may acquire more than one semantic judgment about a same sentence according to the semantic logic rules, in which a semantic ambiguity appears. For example, when the semantic analyzing module 103 analyzes a sentence “I love Flora as well as Felicia”, according to the semantic logical rule of “as well as”, two semantic judgments may be acquired: a first semantic judgment is I love Flora and I also love Felicia, a second judgment is I love Flora and Felicia also loves Flora. The semantic analyzing module 103 determines the keywords of the semantic ambiguity, such as, “I”, “Flora”, and “Felicia”.

The information referencing module 104 searches the word bank 1410, the semantic judgments bank 1411, and the basic semantic database 140 to determine critical information about the keywords. The critical information is the word definitions and the semantic judgments about the keywords. For example, in this embodiment, the critical information can be the semantic judgments about relationship among “I”, “Flora”, and “Felicia”. The semantic analyzing module 103 determines which alternative semantic judgments match with the above semantic logic according to the critical information. The information referencing module 104 establishes an information bank 1412 in the temporary database 141 to store the critical information.

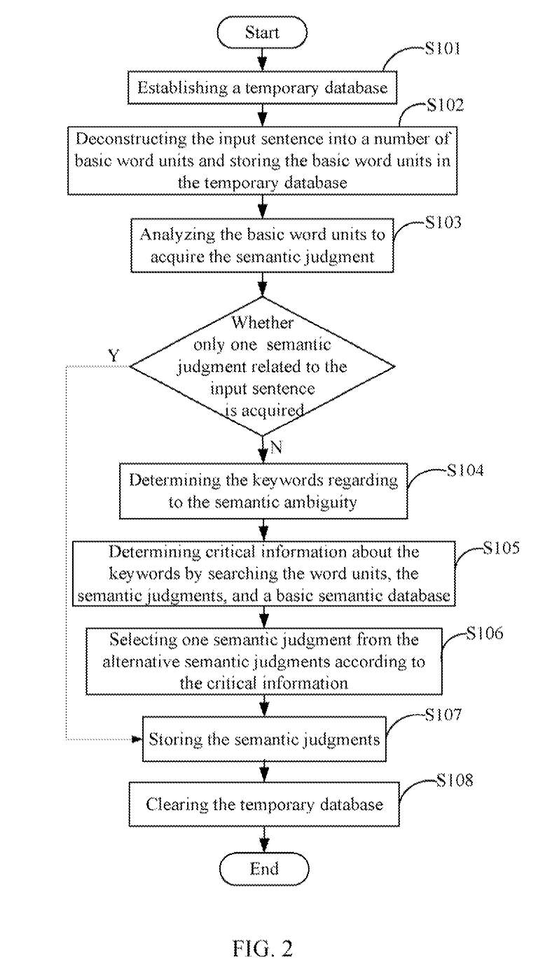

FIG. 2 is a flowchart of an exemplary embodiment of a semantic ambiguity eliminating method. Depending on the embodiment, additional steps may be added, other deleted, and the ordering of the steps may be changed.

In step S101, the buffering module 101 establishes a temporary database 141 in storage device 14 to store the temporary information generated during the semantic analysis process.

In step S102, the sentence deconstructing module 102 deconstructs the input sentence into the basic word units according to the word definitions and the semantic logic rules and stores the basic word units in the word bank 1410. For example, in this embodiment, the input sentence “I love Flora as well as Felicia” is deconstructed into “I”, “love”, “Flora”, “as well as”, and “Felicia”.

In step S103, the semantic analyzing module 103 analyzes the basic word units to acquire the semantic judgments based on the predetermined semantic logic rules stored in the basic semantic database 140.

In step S104, the semantic analyzing module 103 stores the semantic judgments in the semantic judgment bank if the acquired semantic judgments are definite and clear.

In step S105, the semantic analyzing module 103 determines the keywords of the semantic ambiguity if more than one semantic judgment about a same sentence is acquired. For example, in this embodiment, according to the semantic logical rule of “as well as”, two semantic judgments may be acquired: a first semantic judgment is I love Flora and I also love Felicia, a second judgment is I love Flora and Felicia also loves Flora. The semantic analyzing module 103 determines “I”, “Flora”, and “Felicia” as the keywords of the sentence “I love Flora as well as Felicia” because the semantic ambiguity is about the relationships among “I”, “Flora”, and “Felicia”.

In step S106, the information referencing module 104 searches the word bank 1410, the semantic judgments bank 1411, and the basic semantic database 140 to find critical information about the keywords. The critical information is the word definitions and the semantic judgments about the keywords. For example, in this embodiment, the critical information can be some semantic judgments about relationship among “I”, “Flora”, and “Felicia”. The information referencing module 104 stores the critical information in the information bank 1412.

In step S107, the semantic analyzing module 103 selects the correct semantic judgment from the alternative semantic judgments about the same sentence according to the critical information. The semantic analyzing module 103 stores the correct semantic judgment in the semantic judgment bank.

In step S108, the buffering module 101 clears the temporary database 141 when the whole semantic analysis process is finished.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An electronic apparatus, comprising:
an input device that inputs a sentence;
a storage device that stores the sentences, a plurality of word definitions, and a plurality of semantic logic rules; and
a semantic ambiguity reduction system, comprising:
a semantic deconstructing module that deconstructs the input sentence into a plurality of basic word units according to the word definitions and the semantic logic rules;
a semantic analyzing module that acquires the semantic judgments based on the basic word units and the semantic logic rules, stores the semantic judgment if only one semantic judgment about the input sentence is acquired, and determines a plurality of keywords of a semantic ambiguity if more than one semantic judgment is acquired about the input sentence; and
an information referencing module that determines critical information of the keywords by searching the keywords in the word definitions and the semantic judgments being stored;
wherein the semantic analyzing module selects one semantic judgment from the more than one semantic judgments about the same input sentence according to the critical information.

2. The electronic apparatus of claim 1, wherein the semantic ambiguity reduction system further comprises:
a buffering module that establishes a temporary database in the storage device to store temporary information generated during a semantic analysis process.

3. The electronic apparatus of claim 2, wherein the semantic deconstructing module stores the basic word units in a word bank.

4. The electronic apparatus of claim 2, wherein the semantic analyzing module establishes a semantic judgments bank in the temporary database to store the acquired semantic judgments.

5. The electronic apparatus of claim 2, wherein the information referencing module establishes an information bank in the temporary database to store the critical information.

6. The electronic apparatus of claim 2, wherein the buffering module clears the temporary database when the semantic analysis process is finished.

7. The electronic apparatus of claim 1, wherein the critical information is the word definitions and the semantic judgments about the keywords.

8. The electronic apparatus of claim 1, wherein the input device is selected from the group consisting of a microphone, a keyboard, and a touch panel.

9. A semantic ambiguity eliminating method being performed by execution of computer readable program code by a processer of an electronic apparatus, the electronic apparatus comprising an input device that inputs a plurality of sentences and a storage device that stores the sentences, a plurality of word definitions, and a plurality of semantic logic rules, the method comprising:
deconstructing each of the input sentences into a plurality of basic word units according to the word definitions and the semantic logic rules;
analyzing the basic word units to acquire a plurality of semantic judgments based on the predetermined semantic logic rules;
determining the keywords regarding to the semantic ambiguity if more than one semantic judgment about a same sentence is acquired;
searching the word definitions and the above definite semantic judgments to determine critical information about the keywords; and
selecting the correct semantic judgment from the alternative semantic judgments about the same sentence according to the critical information.

10. The method as claimed in claim 9, further comprising:
establishing a temporary database in storage device to store the temporary information generated during the semantic analysis process before deconstructing the sentences.

11. The method as claimed in claim 9, further comprising:
buffering the acquired semantic judgments if the acquired semantic judgments are definite and clear.

12. The method as claimed in claim 9, further comprising:
clearing the temporary database when the whole semantic analysis process is finished.

13. The method as claimed in claim 9, wherein the critical information is the word definitions and the semantic judgments about the keywords.
